(19) United States
(12) Patent Application Publication
(10) Pub. No.: US 2009/0255866 A1
(43) Pub. Date: Oct. 15, 2009

(54) Oil filter arrangement and filter element for an oil filter arrangement

(76) Inventors: Friedhelm Pfitzer, Rangendingen (DE); Alexander Maute, Hechingen-Stetten (DE); Peter Jungmann, Bisingen (DE)

Correspondence Address: DREISS, FUHLENDORF, STEIMLE & BECKER, POSTFACH 10 37 62, D-70032 STUTTGART, DE

(21) Appl. No.: 11/990,988

(22) PCT Filed: May 16, 2006
(86) PCT No.: PCT/EP2006/004578

§ 371 Date: Feb. 26, 2008

(30) Foreign Application Priority Data
Sep. 2, 2005 (DE) 10 2005 042 715.4

(51) Int. Cl. B01D 29/15; B01D 35/30

(52) U.S. Cl. 210/232; 210/443; 210/497.01

(57) ABSTRACT

An oil filter arrangement (10) comprises a housing, which has a receiving chamber (16) for a filter element (18) which can be cross-flowed in a radial manner by oil and which can be inserted into the housing, a support tube (42) which supports the filter element when it is inserted and a cover (14) which can be screwed to the housing (12) via a thread (15). The cover comprises engaging ribs (44) which are used to rotate the filter element (18) when screwing and/or unscrewing the cover (14) to the housing and/or from the housing.

The invention concerns an oil filter arrangement comprising a housing, which has a receiving chamber for a filter element that can be inserted into the housing and through which oil can flow in a radial direction, a support tube that supports the filter element when the filter element is inserted, and a lid that can be screwed onto the housing via a thread.

There is a plurality of oil filter arrangements of this type.

DE 198 59 960 A1 discloses e.g. removal of the filter element including lid element from the receiving chamber for changing the filter element.

It has turned out in practice that the filter element can cake to the housing, the support tube and/or to another component that is supported on the housing and/or on the support tube after longer periods of use of the filter element, in particular, due to the high oil temperatures. Removal of the filter element from the housing for changing the filter element is difficult in this case.

It is the underlying purpose of the present invention to further develop an oil filter arrangement of the above-mentioned type in such a fashion that the filter element can be easily removed and/or changed. Change of the filter element shall, in particular, also be possible when the filter element has caked to the support tube and/or housing.

This object is achieved by an oil filter arrangement of the above-mentioned type in that the lid comprises carrier ribs which turn the filter element when the lid is screwed onto and unscrewed from the housing. This causes movement of the filter element relative to the housing when the lid is screwed on and unscrewed, thereby releasing a filter element that has caked to the housing or to a component on the housing side.

The support tube may thereby advantageously be mounted to the housing in such a fashion that it remains in the housing when the filter element is exchanged. The support tube may thereby, in particular, be locked, screwed and/or mounted like a bayonet and/or undetachably to the housing. For locking, corresponding locking means must be provided. For screwing, corresponding threads and/or screws must be provided. For bayonet-like fastening, the support tube is initially inserted into the receiving chamber along its longitudinal axis, and then fixed through rotation about its longitudinal axis using undercut sections that must be correspondingly provided.

Advantageously, the can-shaped support tube has contact surfaces in the upper and lower end areas of the filter element, against which the filter element tightly abuts. The filter element can cake to the support tube, in particular, on these contact surfaces.

In accordance with a further development of the invention, a spring element may be provided which loads the filter element against the lid when the filter element is inserted and the lid is screwed on. A spring element of this type causes the filter element to be lifted at least to a limited degree when the lid is unscrewed to facilitate its removal from the receiving chamber. A drainage channel provided on the bottom of the receiving chamber may thereby be closed when the filter element is inserted, and the drainage channel may be opened when the filter element is removed. The spring element may thereby contribute to opening of the drainage channel.

In accordance with a further development of the invention, the carrier ribs are advantageously disposed in the radially outer area of the lid inner side, each comprising a radially inwardly projecting carrier section which engages in associated recesses provided on the filter element when the filter element is inserted. The carrier section may thereby have an edge which extends substantially in an axial direction, or may be bent. In a particularly advantageous fashion, several carrier ribs with carrier sections are disposed on the lid at equal distances from each other. The individual carrier ribs then engage in recesses that are correspondingly provided on the filter element.

In accordance with a further embodiment of the invention, centering ribs with centering sections that project in a radial inward direction may be provided in the radially outer area of the lid inner side, which radially center the side of the filter element facing the lid when the lid is disposed and/or screwed on. This ensures that the part of the filter element facing the lid assumes its operating position when the filter element is screwed on. The centering ribs are thereby advantageously designed separately from the carrier ribs. This is advantageous in that, when the lid is screwed on, the carrier ribs do not act in an axial direction against the filter element, thereby possibly impairing its operativeness.

In accordance with a further development of the invention, the centering ribs may comprise contact sections that project in an axial downward direction and act against the front side of the filter element facing the lid when the lid is disposed and/or screwed on. This yields a defined axial downward motion of the filter element when the lid is screwed on until the operating position of the filter element is reached.

In a further embodiment of the invention, the centering section and the contact section of a centering rib are disposed such that they abut. The two sections may advantageously be disposed perpendicularly to each other, wherein the contact section then advantageously extends perpendicularly and the centering section extends parallel to the center longitudinal axis of the support tube.

In accordance with the invention, the carrier ribs and the centering ribs may also be formed by one correspondingly designed rib only. This minimizes the overall number of ribs.

In accordance with the invention, the carrier ribs may moreover project further in the axial direction facing the bottom of the receiving chamber than the centering ribs. This is advantageous in that the carrier ribs can initially engage in their associated recesses on the filter element, before the centering ribs act against the filter element.

In accordance with a further development of the invention, the support tube or a part that is guided on the support tube or housing may comprise a contact section for abutment on the side of the filter element facing away from the lid. If such a contact section is provided, undesired caking or sticking of the filter element to the contact section can be released during unscrewing the lid, since the filter element is simultaneously rotated. The contact section may thereby extend substantially perpendicularly to the center longitudinal axis of the support tube.

In accordance with the invention, the oil filter arrangement may also comprise an associated filter element.

A filter element of this type for an inventive oil filter arrangement has recesses for receiving the carrier ribs provided on the lid of the oil filter arrangement, wherein the recesses have a width which is equal to or slightly wider than the width of the carrier ribs. This ensures that the carrier ribs can be inserted into the recesses.

It is thereby feasible to form each recess by two radially projecting projections. Due to the fact that the recesses are formed by the projections, the recesses do not have a negative effect on the filtering function of the filter element.

It is thereby feasible to provide an insertion web, which projects in an axial direction and has an insertion section that extends in the axial extension of the recess, in the area of the recess, such that when the lid is screwed on, a carrier rib is guided by the insertion section into the associated recess. Such an insertion web consequently represents an insertion aid for the carrier rib. It can be ensured that the respective carrier rib reaches its associated recess when the lid is screwed on. In particular, when the carrier ribs axially project past the centering ribs, it is ensured that only the carrier ribs cooperate with the insertion web in such a fashion that the carrier ribs can gain access to the recesses.

In a further preferred embodiment of the invention, the projections and/or the insertion web is/are formed by an end disc of the filter element. This is advantageous in that the actual filter material remains unimpaired, since changes are made only to the end disc which may, in particular, be produced from plastic material.

Further details and advantageous embodiments of the invention can be extracted from the following description that describes and explains in more detail the embodiment shown in the drawing.

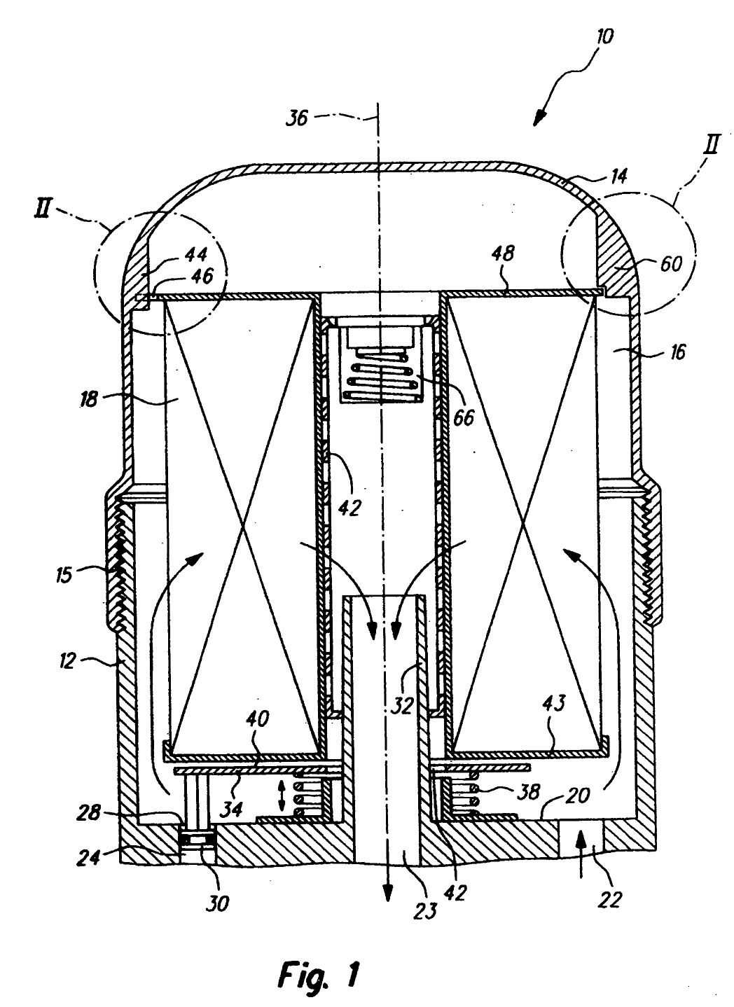

FIG. 1 shows a longitudinal section through an inventive oil filter module;

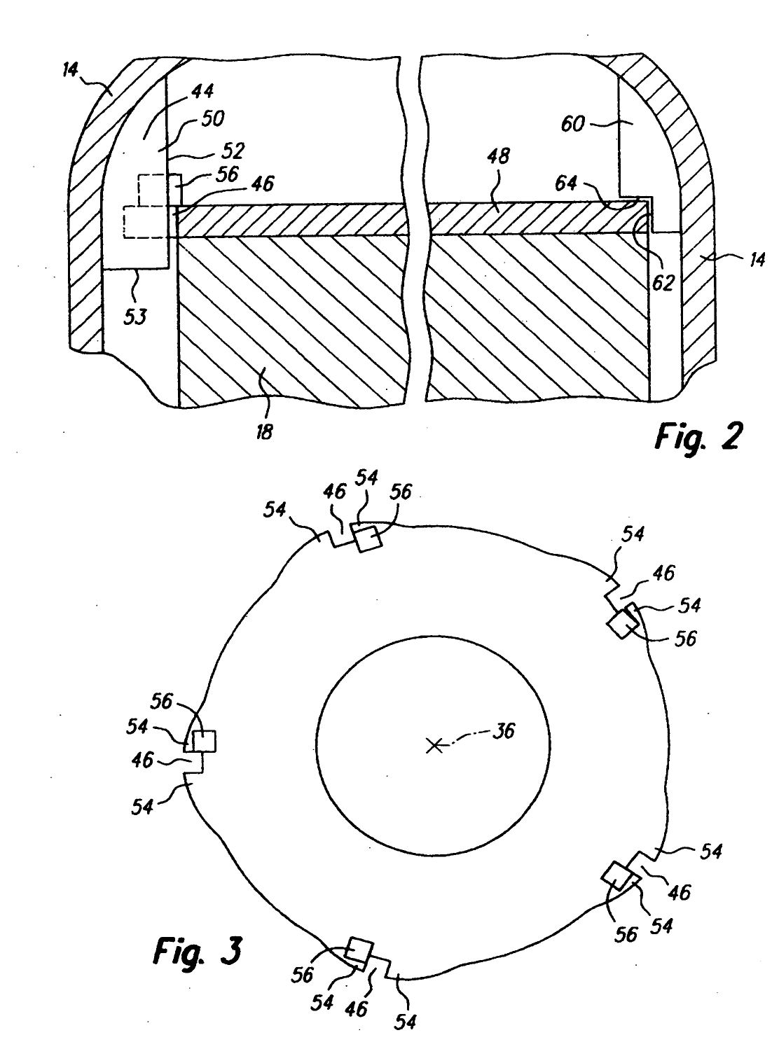

FIG. 2 shows an enlarged view of the areas II shown in FIG. 1;

FIG. 3 shows a top view of a front side of a filter element facing the lid;

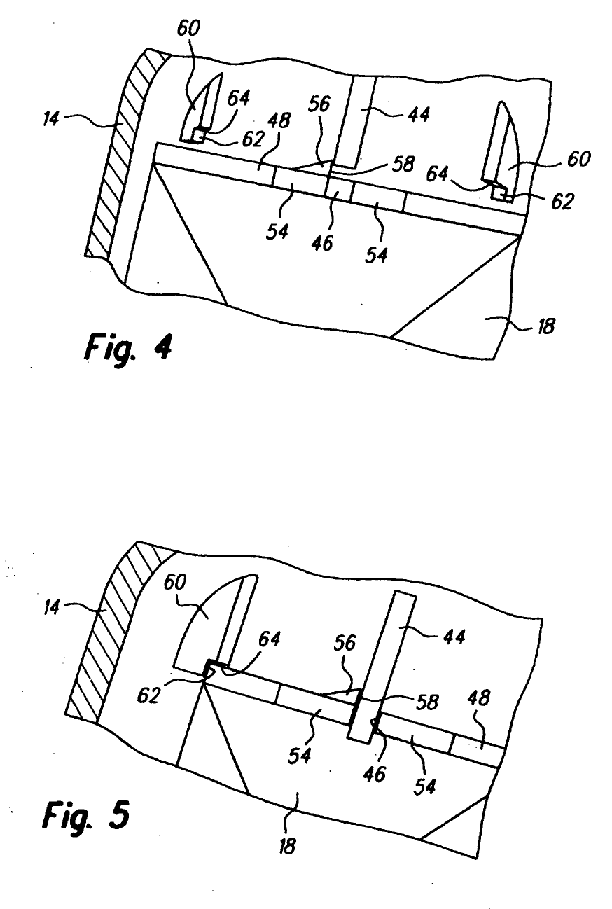

FIG. 4 shows an assembly position of the filter element with the lid not being completely screwed on; and

FIG. 5 shows the operating position with the lid being completely screwed on.

The oil filter arrangement 10 shown in FIG. 1 has a housing 12 and a housing lid 14 that can be screwed onto the housing 12 via a thread 15. The housing 12 has a receiving chamber 16 that contains a filter element 18 through which a flow can pass in a radial direction from the outside to the inside.

The bottom 20 of the receiving chamber 16 has a crude oil opening 22 through which crude oil to be filtered flows into the receiving chamber 16. The filtered crude oil is discharged via a purified oil channel 23. A drainage channel 24 is also provided on the bottom 20 via which the oil in the receiving chamber 16 can be discharged when the housing lid 14 is opened or when the filter element 18 is removed. The drainage channel 24 has a drainage opening 28. The drainage opening 28 is closed by a closing means 30 in the operating position of the filter arrangement, shown in FIG. 1 with closed housing and inserted filter element 18.

The plug-shaped closing means 30 is disposed on a drainage plate 34 that can be axially displaced on a pipe socket 32. The drainage plate 34 has a central opening 42 via which it is disposed onto the pipe socket 32. The drainage plate, that extends perpendicularly to the center longitudinal axis 36 of the filter arrangement, can thereby be axially displaced on the pipe socket 32. The plug-like closing means 30 thereby engages in the drainage opening 28, wherein the drainage channel 26 extends parallel to the center longitudinal axis 36 in the area of the drainage opening 28. This ensures that the drainage channel 24 can be reliably closed independently of the engagement depth of the closing means 30 in the drainage channel 24.

The drainage plate 34 is urged by a pressure spring 38 in an upward direction towards the housing lid 14. The pressure spring 38 is supported on the drainage plate 34 and also on an intermediate sleeve 40 provided on the bottom 20. The intermediate sleeve 40 is thereby advantageously made from a metallic material, wherein the housing 12 may be made from plastic material.

Due to the spring loading of the drainage plate 34, the drainage plate is moved in an axial upward direction when the housing lid 14 is removed, whereby the closing means 30 releases the drainage opening 28 and the oil in the receiving chamber 16 can be discharged via the drainage channel 24. The pressure spring 38 is thereby advantageously designed in such a fashion that when the housing lid 14 is removed, the drainage plate 34 is lifted and the filter element 18 is also moved in an axial upward direction.

The drainage plate 34 which is disposed to be guided on the pipe socket 32 on the housing side has a contact section 40 on its upper side facing the filter element 18 for abutment on the lower end side 43 of the filter element 18.

A support tube 42 through which oil can pass in an axial direction is provided on the housing 12 or on the pipe socket 32. The filter element 18 can be axially disposed onto the support tube 42 when the lid 14 is open. When the filter element 18 is removed from the receiving chamber 16, the support tube remains in the receiving chamber 16.

An overpressure valve 66 is disposed in the area of the upper end of the support tube 42, which opens when a limit pressure is exceeded.

Due to the high temperatures of the oil to be filtered and the long time of operation of the filter element 18, the filter element 18 may cake to the contact section 40 and/or the pressure tube 42. In order to release a caked filter element 18 from the contact section 40 or the support tube 42, carrier ribs 44 are provided on the inner side of the lid 14. The carrier ribs 44 thereby engage in recesses 46 provided on the filter element 18, which are clearly shown, in particular, in the top view of FIG. 4. The recesses 46 are thereby disposed on the upper end disc 48 of the filter element. The carrier ribs 44 and the recesses 46 ensure that, when the lid 14 is turned, the filter element 18 is also simultaneously turned. The filter element 18 can thereby be released from the contact section 40 and from the pressure tube 42.

In the embodiment shown in the figures, a total of five carrier ribs 44 are provided which engage in the five recesses 46 shown in FIG. 3. The carrier ribs 44 are thereby disposed in the radially outer area of the lid inner side and each have a carrier section 50 that projects in a radial inward direction. In FIGS. 1 and 2, the carrier section 50 is radially inwardly limited by an edge 52 extending parallel to the center longitudinal axis 36. The carrier section 50 is limited in the axial direction by the edge 53 extending perpendicularly to the center longitudinal axis 36.

The recesses 46 on the filter element side thereby have a width which is slightly wider than the width of the respective carrier rib 44. This ensures that the carrier ribs 44 can be immersed into the recesses 46.

As is clearly shown, in particular in FIG. 3, each individual recess 46 is formed by two projections 54 projecting in the radial direction. The projections 54 in accordance with FIG. 3 having a wedge-shaped contour, as viewed from the top, are integrally formed on the substantially circular contour of the upper end disc 48, as viewed from the top, and radially project past the actual filter material of the filter element 18. This is advantageous in that the actual filter material is not impaired by the projections 54 or by the carrier ribs 44 that engage in the recess 46.

FIGS. 2 through 5 moreover show that an axially downwardly projecting insertion web 56 is provided on the upper side of the upper end disc 48 facing the lid 14 in the area of each recess 46. The insertion webs 56 have a wedge-like design, as viewed from the side, which is clearly shown, in particular, in FIGS. 4 and 5. Each has an insertion section 58 extending in the axial extension of the respectively associated recess 46, which serves as an insertion aid for inserting the respective carrier ribs 44 into the recess 46.

When the filter element is changed, the filter element 18 is initially inserted into the receiving chamber 16. The lid 14 is then screwed onto the housing 12 via the thread 15. When the lid 14 is screwed on, the carrier ribs 44 initially meet the insertion sections 58 of the insertion webs 56. The filter element 18 is thereby carried along by the lid 14 and turned about the longitudinal axis 36. With continued screwing on of the lid 14, the carrier ribs 44 slide in an axial direction into the recesses 46.

Both carrier ribs 44 as well as centering ribs 60 are disposed on the inner side of the lid 14. One centering rib 60 is advantageously provided between two respective carrier ribs 44, wherein the centering ribs 60 may also be disposed at equal distances from each other. The centering ribs 60 have radially inwardly projecting centering sections 62 which center the filter element 18 in the area of the upper end disc 48 while the lid 14 is being screwed on. The centering ribs moreover have contact sections 64 facing in an axial downward direction, i.e. facing the upper end disc 48, which act against the end disc 48 facing the lid 14 when the lid 14 is screwed on, and force the filter element 18 in a radially downward direction.

The carrier ribs 44 project further in the axial direction facing the bottom 20 of the receiving chamber 16 than the centering ribs 60, as is clearly shown, in particular, in FIGS. 1 and 2. In consequence thereof, the carrier ribs 44 cooperate with the insertion webs 56 and not with the centering ribs 60 when the lid 14 is disposed and screwed on.

FIG. 5 shows the operating position, in which the carrier ribs 44 engage in the recesses 46 and the contact sections 64 load the filter element 18 in a radial downward direction against the spring force of the pressure spring 38.

1-12. (canceled)

13. An oil filter arrangement for a filter element, the arrangement comprising:
a housing defining a receiving chamber to accommodate the filter element therein, said housing structured to effect radial oil flow through the filter element;
a support tube that supports the filter element when the filter element is inserted in said housing, said support tube having bearing surfaces disposed at upper and lower end regions of the filter element for sealed seating of the filter element, said support tube mounted to said housing in such a fashion as to remain in said housing when the filter element is exchanged;
a lid screwed onto the housing via a thread, said lid having carrier ribs that simultaneously turn the filter element when said lid is screwed onto or unscrewed from said housing; and
a spring element structured and disposed to load the filter element against said lid when the filter element is inserted and said lid is screwed on.

14. The oil filter arrangement of claim 13, wherein said carrier ribs are disposed in a radially outer area of a lid inner side, each of said carrier ribs having a radially inwardly projecting carrier section which engages in recesses provided therefor on the filter element when the filter element is inserted.

15. The oil filter arrangement of claim 14, wherein said lid defines centering ribs having radially inwardly projecting centering sections and disposed in a radially outer area of said lid inner side to radially center a side of the filter element facing said lid when said lid is disposed and/or screwed on to said housing.

16. The oil filter arrangement of claim 15, wherein said centering ribs have axially downwardly projecting contact sections which act against a side of the filter element facing said lid when said lid is disposed and/or screwed on to said housing.

17. The oil filter arrangement of claim 16, wherein said centering sections and said contact sections of said centering ribs are disposed in such a fashion as to border each other.

18. The oil filter arrangement of claim 16, wherein said carrier ribs form said centering ribs, each having one said centering section and/or one said contact section.

19. The oil filter arrangement of claim 15, wherein said carrier ribs project further in a axial direction towards a bottom of said receiving chamber than said centering ribs when said lid is disposed on said housing.

20. The oil filter arrangement of claim 13, wherein said support tube or a part guided on said support tube or on said housing has a contact section for abutment on a side of the filter element facing away from said lid.

21. The oil filter arrangement of claim 13, comprising the filter element as claimed.

22. A filter element for the oil filter arrangement of claim 13, the filter element having recesses for receiving carrier ribs provided on said lid of the oil filter arrangement, wherein said recesses have a width which is equal to or slightly wider than a width of said carrier ribs, wherein an insertion web projecting in an axial direction is disposed proximate one said recess and has an insertion section extending in an axial extension of said recess, such that, when said lid is screwed onto said housing, said insertion section guides said carrier rib into an associated said recess.

23. The filter element of claim 22, wherein each said recess is formed by two projections, extending in a radial direction.

24. The filter element of claim 22, wherein said projections and/or said insertion web is/are formed by an end disc of the filter element.
